(19) United States
(12) Patent Application Publication
(10) Pub. No.: US 2022/0371128 A1
(43) Pub. Date: Nov. 24, 2022

(54) APPARATUS FOR HIGH-SPEED PROCESSING OF FABRICS

(71) Applicants: Michael Carl CHASE, Dover, PA (US); Dave WOLFE, Hanover, PA (US); John Madden MATHY, Stewartstown (US); Xinpeng DU, Orlando, FL (US); Xiaoming YU, Orlando, FL (US); Aravinda KAR, Orlando, FL (US); Arifur RAHAMAN, East Palo Alto, CA (US); ELSNER ENGINEERING WORKS, INC., Hanover, PA (US)

(72) Inventors: Michael Carl CHASE, Dover, PA (US); Dave WOLFE, Hanover, PA (US); John Madden MATHY, Jr., Stewartstown, PA (US); Xinpeng DU, Orlando, FL (US); Xiaoming YU, Orlando, FL (US); Aravinda KAR, Orlando, FL (US); Arifur RAHAMAN, East Palo Alto, CA (US)

(21) Appl. No.: 17/766,041

(22) PCT Filed: Oct. 3, 2020
(86) PCT No.: PCT/US2020/054186

§ 371 Date: Apr. 1, 2022

Related U.S. Application Data
(60) Provisional application No. 62/910,938, filed on Oct. 4, 2019.

(51) Int. Cl. B23K 26/38; B23K 26/08; B23K 26/082; B23K 26/046; B23K 26/70; B23K 26/0622; D06M 10/00

(52) U.S. Cl. CPC B23K 26/38; B23K 26/083; B23K 26/082; B23K 26/046; B23K 26/705; B23K 26/0622; D06M 10/005; B23K 2103/38

(57) ABSTRACT

An apparatus for laser processing of very wide non-woven fabric materials at high speeds. This invention enables a laser beam to sever, perforate and pattern a large piece of fabric materials planarly disposed at regular or irregular spatial intervals over the entire width while the fabric passes from one roller to another roller at high speeds by precisely managing focus and intensity of the beam at the focal point on the web. A control system managing the laser processing system enables rapid reconfiguration of perforation patterns. The fabric can be woven or nonwoven, homogeneous or nonhomogeneous material with uniform or nonuniform thickness. An optical sensor is provided to sense the laser processing as it is performed and provide feedback to a system controller to optimize laser processing performance in real time.

### CROSS-REFERENCE TO RELATED APPLICATIONS

This application claims priority to and benefit of U.S. Provisional Application 62/910,938, filed Oct. 4, 2019, and titled “APPARATUS FOR HIGH-SPEED PROCESSING OF FABRICS” and PCT Application No. PCT/US2020/054186, filed Oct. 3, 2020, and titled “APPARATUS FOR HIGH-SPEED PROCESSING OF FABRICS” both of which are hereby incorporated by reference in their entirety.

### BACKGROUND OF THE INVENTION

The present invention relates generally to method and apparatus for high-speed processing of fabrics, and, more particularly to an apparatus for laser processing of a wide web of non-woven fabric translating at a high speed in a web processing machine.

Converting machines for processing wide webs of material into usual sizes and/or configurations generally require moving the web at high speed to achieve production efficiency. Such machines typically process a wide web of material, ranging up to 110 cm (approximately 43 in) in width, moving through the machine at speeds up to 3.6 m/s (700 ft/min). Cutting and perforation operations are conventionally performed by rolls or the like which span transversely across the web and contact the web to cut or perforate the material. Perforation spacing along the web may be a close as 100 mm (4 in) using a perforation pattern that varies the tab (portion of the web not severed) as between 0.5 mm and 2 mm on spacing ranging from 6 mm to 25 mm. Changing perforation patterns when using mechanical perforation means requires significant machine down-time, on the order of 2 to 4 hours) in order to change perforation cutter elements. Such downtime represents a significant loss of production.

Lasers have been shown to be suitable for performing certain processing operations on some materials. Lasers do not wear as do mechanical cutters and thus require no periodic sharpening. They further have the benefit of being easily reconfigured to implement a desired perforation pattern or to accommodate different material characteristics with minimal machine downtime. Known laser processing systems, however, are generally limited to processing speeds up to 0.5 m/s (100 ft/min), well below the capabilities of machines using mechanical perforation means.

In addition to speed, perforation quality has been problematic in laser systems. In laser materials processing the scanning area is limited by the extent to which the laser focus can be maintained on a surface of a planar workpiece. Advancement of laser processing has been directed toward processing of metals, ceramics, glasses, and polymers since lasers have good flexibility, precision, and repeatability. Pulsed laser, especially femtosecond or picosecond lasers create insignificant heat affected zones on the workpiece which would require post-process heat treatment, produce clean processing quality, and offer good physical repeatability.

Two approaches are generally employed. The first is to utilize a laser head positioned above the workpiece with a height fixed at the focal length of the converging lens in the laser head. The laser head is moved by mechanical means, typically a chain/belt drive, to sweep the laser beam across the workpiece. This configuration can be slow in scanning, limited by the mechanical motion mechanism to far less than the 2,100 perforations per minute possible using mechanical perforators.

The second is to utilize a flat field scanning lens, commonly referred to as an f-theta lens, to deliver the laser beam to the workpiece with a flat focal plane. Conventional spherical lens optics used with beam scanners can only maintain focal precision on a curved plane. An f-theta lens addresses the limitations of spherical lens by allowing the focal precision to be maintained in a flat plane, but often has limited a field of view. To date, it has remained challenging to simultaneously obtain a fast scanning speed across large field of view and acceptably maintain the focal spot size and laser intensity necessary to produce the desired results.

Known laser processing systems cannot maintain acceptable beam focal precision and intensity control necessary for commercial production efficiency on fabric webs. This is primarily the result of limitations in maintaining precision focus of laser on the web material as the beam sweeps across the full width of a material web. In order to increase the processing area, the conventional approach is to increase the size of the laser focal spot which correspondingly reduces the peak intensity and spatial resolution of the beam. Beam sweep rate and the inability to maintain precise control of beam focus and power limit the speed at which the material web can be processed by the laser and thus restrict production efficiency.

Adaptive optics have been widely developed to dynamically correct the aberration in laser beam wavefronts. The wavefront is a 2D map of the phase on a plane normal to the wave propagation direction. To the first order, wavefront aberration is due to the difference of the optical path length (OPL) among different beam tracing paths. Similarly, by introducing OPL change, the wavefront can also be modified to compensate for the aberration. By adding Zernike modes to the laser beam wavefront, the axial (along the beam propagation direction) location of the focal spot can be tuned within a range larger than the confocal length (two times the Rayleigh length), while maintaining the lateral spot size (and thus peak intensity and resolution) throughout the tuning range.

Deformable mirrors are one type of adaptive optics devices that can be used to change the wavefront. A deformable mirror consists of many mirror segments that can be controlled independently to shift and/or tilt. As any wavefront can be decomposed into Zernike modes and low-order Zernike modes can be achieved by setting each segment mirror at the right shift and tile angle, any wavefront can be obtained by the superposition of all segment mirrors, thus compensating wavefront distortion and expanding the size of webs upon which the laser may applied.

It would be advantageous to provide a method and apparatus allowing a laser-based web processing system to be used on a web of fabric material that extends the processing area by controlling the wavefront of the laser beam using adaptive optics allowing for precision control of beam focus and intensity thereby enabling an increase web processing speeds in roll-based machines. Additional advantages would be realized by a laser-based web processing system that could be easily reconfigured to implement different perforation patterns or accommodate different web materials. Further advantages would be realized by a laser-based system incorporating optical feedback of the laser processing to enable real-time optimization and refinement of the web process.

### SUMMARY OF THE INVENTION

Accordingly, the present invention, in any of the embodiments described herein, may provide one or more of the following advantages:

It is an object of the present invention to provide a laser-based processing system for implementing a perforation process on a web of non-woven fabric material moving at high speed through a web-processing machine that matches material throughput of comparable mechanical-based perforation processing system.

It is also an object of the present invention to provide a laser-based processing system for implementing a perforation process on a web of non-woven fabric material wherein laser operation is managed by a controller that enables perforation characteristics to be easily reconfigured, up to and including in real time during operation of the machine. Additionally, optical sensors may be included to provide feedback to the controller and enable real-time adjustment of the laser to accommodate variations in web characteristics and provide optimal web perforation.

It is another object of the present invention to provide a laser-based processing system for implementing a process on a web of material moving at high speed through a web-processing machine wherein a beam focal-point adjusting mechanism that maintains the focal point of laser precisely on a path defined by the intersection of material web and the line in the plane of the web in which the laser sweeps across the width of the web. Adjusting the focal point enables a single laser to effectively process a wide web of material using optimal laser power to minimize damage to the web material.

It is another an object of the present invention to provide a laser-based processing system for implementing a process on a web of material moving at high speed through a web-processing machine wherein laser power imparted to the web material is managed through precise control of the laser to optimize the laser for the process to be performed and the characteristics of the web material.

It is a further object of the present invention to provide a laser-based processing system for implementing a process on a web of material moving at high speed through a web-processing machine wherein power distribution within the laser beam wave front is adjusted to optimize beam cutting effectiveness based on properties of the web material. Precise control of beam power is essential with materials such as non-woven fabrics which are easily charred or discolored by excess laser energy. Beam power control also allows adjustment so that the beam can be configured to deliver enough energy to cleanly cut denser materials such as foils or films.

It is a still further object of the present invention to provide a laser-based processing system for implementing a process on a web of material moving at high speed through a web-processing machine wherein laser power imparted to the web material is managed through precise control of laser pulse frequency and pump current magnitude to optimize the laser for the process to be performed and the characteristics of the web material.

The present invention overcomes the above limitations by providing an apparatus for laser processing of very wide non-woven fabric materials at high speeds. This invention enables a laser beam to sever, perforate and pattern a large piece of fabric materials planarly disposed at regular or irregular spatial intervals over the entire width while the fabric passes from one roller to another roller at high speeds by precisely managing focus and intensity of the beam at the focal point on the web. A control system managing the laser processing system enables rapid reconfiguration of perforation patterns. The fabric can be woven or nonwoven, homogeneous or nonhomogeneous material with uniform or nonuniform thickness. An optical sensor is provided to sense the laser processing as it is performed and provide feedback to a system controller to optimize laser processing performance in real time.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 provides a diagram of a first embodiment of the present invention including a dynamic focus system in the form of a deformable mirror;

FIG. 2 provides a diagram of a second embodiment of the present invention including a dynamic focus system in the form of a f-Theta lens;

FIG. 3 illustrates the change in the beam focal length as the beam is swept across the width of the material web;

FIG. 4 illustrates the beam sweep path needed to produce a perforation that is perpendicular to the direction of the web movement;

FIG. 5 illustrates the sensing arrangement for adjusting the laser processing system to provide optimal processing of the web;

FIG. 6 illustrates a change of the wavefront using the dynamic focal adjuster;

FIG. 7 illustrates an alternate reflector and beam converging means for use with the invention;

FIG. 8 is a section view of FIG. 7 taken along cut line 8-8; and

FIG. 9 is a section view of FIG. 7 taken along cut line 9-9.

### DESCRIPTION OF THE PREFERRED EMBODIMENT(S)

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right,” “forward” or “rearward” are used as a matter of convenience and are determined by the viewing in the direction of material movement as it is processed in the machine. “Upward” and “downward” orientations are relative to the ground or operating surface as are any references to “horizontal” or “vertical” planes. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail. When referring to the figures, like parts are numbered the same in all figures.

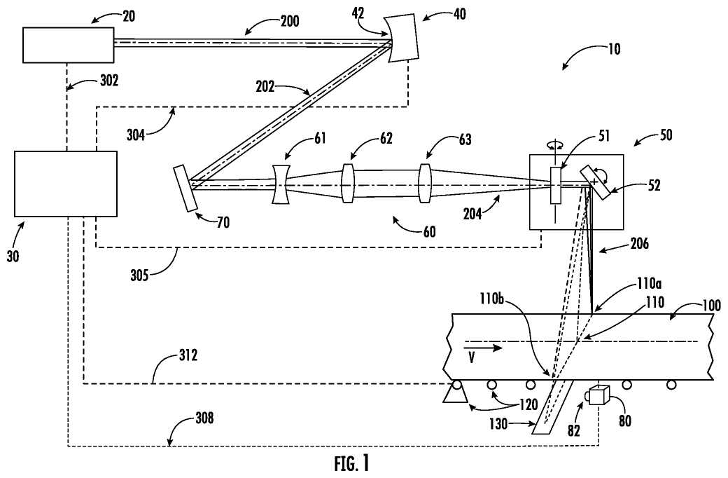

A first embodiment of the invention utilizes a dynamic focal adjustment system to maintain precise beam focus as the beam is swept transversely across the web. In this arrangement, a scanner is used to sweep the laser beam to transversely across the web and a dynamic focal adjustment system is applied to change the laser focus constantly during the beam sweep perforation to maintain it precisely focused on the web surface. One exemplar dynamic focal adjustment system is a deformable mirror. The web is maintained in a planar (flat) arrangement during this process. The advantages of this embodiment are that the operation may be performed on the web without altering the web feed path from a planar arrangement. Noted disadvantages include a need for synchronizing instrumentation related to web speed and laser motion control and the difficultly in maintaining precise optical alignment. FIG. 1 illustrates the basic arrangement of this embodiment.

The dynamic focal shift approach is preferred as it allows the beam sweep speed to be sufficiently fast to enable operation with desired web travel speeds and web widths. Other embodiments were considered but discounted based on inherent limitations of the designs. A mechanical drive oscillating an optical emitter transversely across the material web was considered. Such drive mechanisms are mature in the market making acquisition and maintenance of the mechanism easier. They offer a very small focal point which applies very high laser intensity onto the web due to proximity of the laser to the web which in turn allows the use of a low power (lower cost) laser. Noted disadvantages of the oscillating this embodiment include limited scanning speed due to limitations of a mechanical drive system (˜4 m/s versus a target optical head drive speed of 40 m/s), additional safety features necessary on the machine for personnel protection from mechanical drive failure; and material wear and fatigue concerns.

Laser processing of web materials in non-planar configurations may also be accomplished provided characteristics of the configuration are known and the dynamic focal adjustment system is adjusted accordingly. An embodiment in which the web is curved in the area swept by the laser to match the curved focal plane of the scanner without dynamic focal adjustment to minimize variations in focal length as the laser traverses the web width was also considered. While it enjoys many advantages of the dynamic focal shift approach in terms of processing speed and eliminated the need for a dynamic focal shift mechanism, difficulty in transitioning a high-speed material web from a flat to uniformly curved orientation and then returning to a flat orientation offset those advantages and may make the approach impractical depending for some web materials.

An embodiment incorporating a device to reciprocating the beam optics mechanically up-and-down motion wherein the beam is directed to an inclined mirror positioned above the web to deliver the laser beam transversely across the web as the optics reciprocate was considered. A dynamic focal adjustment system may be incorporated to modulate the wavefront of the laser to manage the beam size and shape after reflection by the inclined mirror. Advantages of this embodiment are that it operates on a flat material web and affords a compact optical head and focal change system. Disadvantages include the necessarily large size and high optical quality of the inclined mirror and that a focal change system is necessary to compensate for the web travel speed.

Through prototype testing, embodiments incorporating a dynamic focal change system and that minimized the use of mechanical drive systems to move the laser or an optical scanner apparatus were determined to provide the best balance of capability and economics.

A first embodiment of a beam delivery system incorporating dynamic focal adjustment is illustrated in FIG. 1. The laser beam delivery system 10 comprises an ultra-fast laser (including the laser head, power supply and chiller) 20 which emits a beam 200, a controller 30 for managing operation of the laser beam delivery system via signal conductors 302, 304, 305, 308, 312, a collimation system 60 comprising one or more lens 61, 62, 63 to adjust divergence of the beam to a nominal focal length f₀ corresponding to a reference position 110 on the first surface 101 of the web 100, a galvanometer scanner 50 comprising a power supply and one or more moveable mirrors 51, 52 for directing the beam transversely across a first surface 101 of the web adjacent to the beam source, and a dynamic focal adjuster 40 in the form of a deformable mirror (including a mirror assembly and a driver) 42 for focusing the beam as it is deflected by the scanner 50 transversely across the web surface from the reference position to an adjusted focal length f₁. Additional mirrors 70 may be provided to redirect the beam to suit spatial limitations in which the system may be positioned. The laser beam delivery system 10 is adapted for use with a conventional web processing machine having a feed path for delivering the web of material 100 to the laser beam delivery system 10 for processing. Movement of the web along the feed path is effected by one or more rolls comprising the feed conveyor 120 which may be powered or otherwise managed to control the speed of the web through the machine. Speed control of the feed conveyor 120 is managed by controller 30 and coordinated with operation of the laser beam delivery system 10.

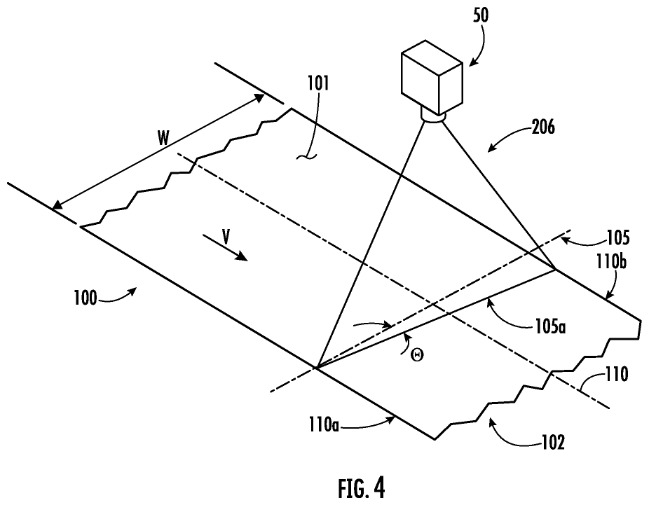

Referring to FIG. 4, the controller 30 may also adjust the angle of the beam sweep axis 105a by an angle ⊖ relative to an axis transverse 105 to the direction of web movement, illustrated as direction V in FIG. 4. This angle adjustment is necessary to offset the distance the web travels during the time interval of the beam sweep so that the resultant laser processing of the web is transverse (perpendicular) to the web. In the exemplar machine, the web is moving along the feed path at a speed up to 3.6 m/s (700 ft/min). The speed of the beam sweep is necessarily fast to accommodate the desired minimum perforation spacing along the web of approximately 100 mm (4 in) which equates to approximately 2,100 sweeps of the beam across the web each minute (˜35 Hz sweep rate).

The laser beam is the means to perforate the web material by ablation of the web. Precise control of beam power and intensity is essential. Materials such as propylene-based non-wovens are easily charred or discolored by excess laser energy. The system should be sufficiently capable to deliver enough energy to cleanly cut denser materials such as foils or films. For perforating processes, the scanner 50 directs the shaped and focal length adjusted laser beam 204 transversely across the web, momentarily interrupting the beam to leave portions of the web unsevered in the desired perforation pattern. Alternatively, the beam of the laser 20 itself may be momentarily interrupted (shuttered to an OFF state) to leave portions of the web unsevered to create the desired perforation pattern. Typical perforation patterns vary the tab width (portion of the web not severed) between 0.5 mm and 2 mm with spacing between tabs (severed portion of the web) ranging from 6 mm to 25 mm. The laser 20 may also be continuously operated during the sweep to completely sever the web along the beam path.

An exemplar laser 20 is a PHAROS model femtosecond laser supplied by Light Conversion, UAB, configured with a Gaussian beam central wavelength of 1027+/−5 nanometer (nm), a pulse duration of 170 femtosecond (fs), a repetition frequency of 1 kHz and a maximum average power of 6 watt (W). Adjustments in the pulse duration and/or repetition frequency enable the power delivered to the web to be managed. Best results for perforating one web material commonly processed with this method are obtained with a power delivery to the web of 1.8 watt (W).

The collimation system 60 receives the focal length adjusted beam 202 from the deformable mirror 42 and shapes the beam being directed to the scanner 50, creating a focal length adjusted and shaped beam 206. This step improves the beam shape at the point where the beam impinges upon the first surface 101 of the web to provide the required beam intensity and improve web cutting/perforating performance. The collimation system 60 comprises one or more lens 61, 62, 63 to adjust divergence of the beam to a nominal focal length f₀ corresponding to a reference position 110 on the first surface 101 of the web 100. Collimating controls the energy distribution across the beam width to produce a more uniform energy distribution within the beam. The effect is to produce cleaner “cuts” of the web material.

Laser intensity may also be manipulated by the controller 30 and/or the collimation system 60 to increase the absorptance of laser energy by the fabric or web, whether in real-time during operation or, preferably, during an initial machine setup configuration for a known web material. Manipulation of laser intensity may also enable the use of a lower powered and hence more economical laser to be used in a given process application. Webs of nonwoven materials are generally very thin, and, in some cases, the fibers are netted very sparsely resulting in large void space in the web media which reduces the energy absorption by the web. Increasing the absorption of laser energy by the web to for ideal perforation performance may be accomplished by operating the laser at a very high intensity so that the atoms and molecules of the web can absorb multiple photons simultaneously or sequentially. Increasing beam intensity enhances the absorptance of the web while allowing a lower power laser to be used. This mechanism modifies the refractive index of the web material and thus shifts the wavelength of the original incident laser beam. The shifted wavelength interacts differently with the web and, therefore, can impart more energy in the web than the non-manipulated laser beam. Manipulation of laser intensity may also enable the use of a lower powered and hence more economical laser to be used in a given process application.

The laser pulse shape may also be modulated by the controller 30 to increase the temporal gradient of the pulse (i.e., the derivative of the laser intensity (I) with respect to time (t), dl/dt) sufficiently so that the Self-Phase Modulation (SPM) occurs in the web. This mechanism shifts the wavelength of the original incident laser beam thereby modifying the refractive index of the web material from the linear absorption portion of the spectrum to the non-linear absorption portion of the spectrum. The shifted wavelength interacts differently with the web and, therefore, causes greater energy absorption by the web than the original non-shifted beam wavelength.

The exemplar collimation system 60 includes a Thorlabs model LC1120-B first lens 61 having a focal length of −100 mm, a Thorlabs model LA1908-B second lens 62 having a focal length of +500 mm, and a Thorlabs model LA 1464-B third lens 63 having a focal length of +1000 mm.

The scanner 50 controls movement of the laser beam across the web from an initial position 110a to a final position 110b. For perforation, the scanner 50 provides a signal indicative of the beam impingement position on the web to the controller 30. The controller 30 then initiates a signal to cycle the laser beam between a mark mode (ON state) and jump mode (OFF state) during the beam sweep to generate the desired perforation patterns on the web. The exemplar scanner 50 is an x-y scanner model hurrySCAN®20 manufactured by SCANLAB.

The deformable mirror 42 is an optomechanical device capable of changing its shape to correct and/or/adjust the wavefront of the laser beam based on the distance between the optics and the first surface 101 of the web where the beam is being directed. The deformable mirror 42 may be calibrated at multiple positions across the web width and an interpolation algorithm applied to set the coefficient in the dynamic focal adjustment process. The deformable mirror 42 may include pre-defined settings for common scanner configurations (e.g., transverse sweep of a planar surface from an elevated fixed location. Establishing the deformable mirror 42 setting changes the laser focal length as the laser beam scans across the web width ensuring that the beam focus is precisely positioned on the first surface 101 of the web. The exemplar deformable mirror is a model PTT111 manufactured by Iris AO.

The controller 30 comprises computer hardware and software necessary to manage operation of the system 10. The controller 30 is operable to receive input signals from and direct output signals to the laser 20, the dynamic focal adjuster 40, the web conveyor 120, and the galvanometer scanner 50 via signal conductors 302, 304, 305, 308, 312. The controller 30 dynamically adjusts laser beam focus using the dynamic focus adjuster 40 as the beam is scanned across the material web 100. In the exemplar system, the controller 30 comprises a conventional personal computer running a custom control application created in LabVIEW® and MATLAB® programming and simulation software.

Laser operation, focus adjusting, and scanner operation and synchronization are software controlled via the controller 30. Inputs may be provided by pre-developed file upload or directly into the control computer system using a user interface with the system (e.g., control input station comprising a monitor and input device). This enables the configuration of the laser beam delivery system 10 to be easily input or modified. The modular arrangement enables each sub-system to be separately configured and tested. Perforation parameters (e.g., perforation speed and position of each cut and notch) defining a desired perforation configuration, material properties and the like can be pre-defined in a library of input files to allow easy selection by a user. The deformable mirror 42 can be activated or deactivated, depending on the width of the web and the precision with which beam focus must be maintained for the web process. The laser state can be independently controlled through a pulse selector typically built into the laser sub-system. The scanner can be independently controlled for the speed and position as well as the iterative progression. Each module includes error monitoring to enhance system set up and trouble shooting. While such inputs are normally provided when the machine is set up for a given run of material, the system is capable of real-time adjustment.

Control of the beam wavefront is essential for maintain perforation quality on the web. In the absence of a dynamic focal adjuster the beam remains focused only within its confocal range. In the exemplar embodiment, this limits focal control to approximately one-quarter of the workpiece width. Outside of this range the spot is out of focus as the optical path length to the edge of the web differs from the optical patch length to the center of the web. Using the dynamic focal adjusted to control the wavefront at each position at which the beam interacts with the web allows consistent beam interaction with the web (ablation) across the entire width of the web.

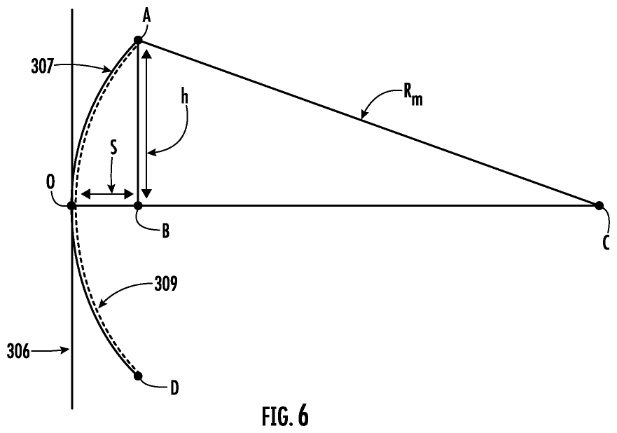

The change of the wavefront using the dynamic focal adjuster is explained with reference to FIG. 6. A wavefront model establishes the focal plane position as a function of beam impingement position with the web, expressed using the lateral centerline of the web as a zero-reference point. The curvature change of the dynamic focal adjuster as a function of the sag distance s (distance OB) is determined by the Modal 4 Zernike coefficient. The calculated dynamic focal adjuster curvature AOD (solid line 307) is approximated by a spherical curvature AOD (dashed line 309). The radius of the curvature of the sphere is Rm centered at point C. The height of the edge point to the optical axis (OC) is h. Zemax modeling optimizes the Zernike coefficient to focus the laser beam at given image plane positions. Initially, the dynamic focal adjuster is set based on a flat reference plane 306 corresponding to the reference position 110 (identified as point “O” in FIG. 6). When the Zernike modes are set to change the phase, the surface becomes nonplanar. The entire optical system in the exemplar system is axisymmetric, so only the defocus mode (Modal 4) of the Zernike series is considered. The polynomial expression of Zernike Modal 4 Z4 in cylindrical coordinate system is:

Z₄=(\sqrt{3}(2p²−1)

where p is the radial distance normalized to the aperture.

The curved surface profile AOD of the dynamic focal adjuster is a paraboloid expressed by the Zernike Modal 4 scaled by a coefficient A4. The calculated paraboloid curvature is approximated by the curvature of a spherical surface passing the points A, O and D. Assuming the center of the sphere is at C, then the radius of the curvature of the sphere is Rm (length of AC). The entrance diameter of the exemplar dynamic focal adjuster is 3.5 mm (h=1.75 mm as shown in FIG. 6). For the sag distance s (OB), it is equivalent to the length difference between p=0 and p=1

A₄Z₄=\sqrt{3}A₄(2p²−1)⇒s=2\sqrt{3}A₄

The radius Rm can be calculated in the right triangle ABC as:

$${R}_{m}^{2} = {( {R}_{m} - s )}^{2} + {h}^{2} ⇒ {R}_{m} = \frac{{h}^{2} + {s}^{2}}{2 s} \approx \frac{{h}^{2}}{2 s} = \frac{{h}^{2}}{4 \sqrt{3} {A}_{4}}$$

The square of the sag distance is very small compared to the square of h and may be omitted in the calculation.

The incident wavefront radius of curvature at the entrance of the exemplar dynamic focal adjuster is Ri=19 m. Assuming the angle between the laser propagation direction and the normal of the dynamic focal adjuster is small, the resultant wavefront radius Ro of curvature after the dynamic focal adjuster can be calculated as:

$$\frac{1}{{R}_{i}} = \frac{1}{{R}_{o}} + \frac{2}{{R}_{m}}$$

As a result, the curvature of the resultant wavefront can be controlled by setting the Modal 4 coefficient A₄. Thus, the image plane position can be adjusted by setting A₄.

Setting the Modal 4 coefficient A₄ to change the image plane position is a “forward method” of modelling the optical system. A “backward method” is to set the image plane position and determine A₄ to achieve focus on the image plane. The backward method has proven more beneficial as the working distance focal length is known and can be set in advance.

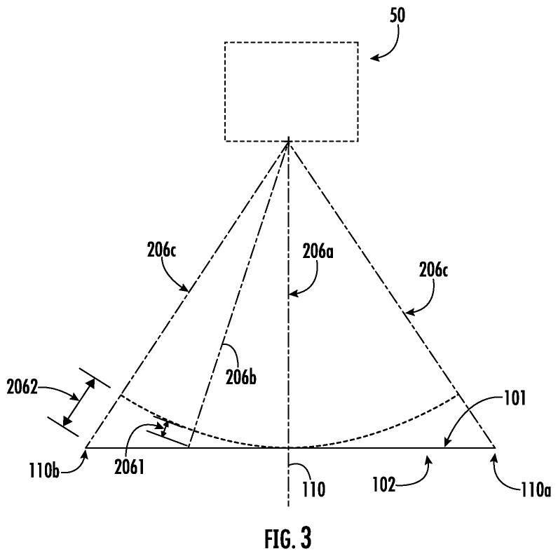

In the exemplar embodiment, the web 100 has a width W of 107 centimeters (42 inches) and is moving through the web processing machine at a speed V of up to 3.6 m/s (700 ft/min). The web 100 is disposed in a plane which results in changes in the length of the beam from the scanner 50 to the point of impingement with adjacent surface 101 of the web as the beam sweeps across the web. Centering the scanner 50 in relation to the width of the web, a nominal focal length f₀ (represented by 206a in FIG. 3), establishes the minimum focal length; adjustments to focal length as the beam impinges portions of the web displaced from the web centerline require an incremental increase 2061 in the focal length f₀+d (represented by 206b in FIG. 3) as the beam impingement position displacement from the web centerline 110 increases. As the beam impingement position displacement from the web centerline 110 reaches its maximum at the edge of the web 110a, 110b, the maximum focal length value f₁ (represented by 206c in FIG. 3) is requiring an maximum increase 2062 over the nominal focal length f₀ (represented by 206a in FIG. 3).

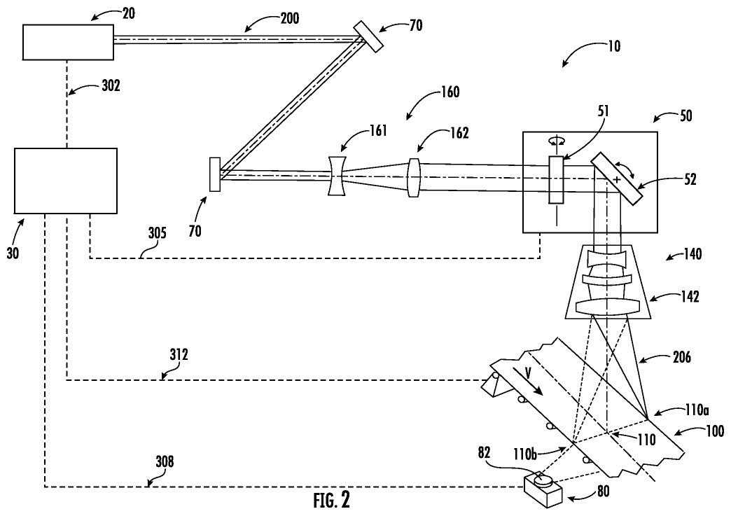

A second embodiment of a beam delivery system incorporating dynamic focal adjustment is illustrated in FIG. 2. The laser beam delivery system 10 comprises an ultra-fast laser (including the laser head, power supply and chiller) 20 which emits a beam, a controller 30 for managing operation of the laser, a collimation system 160 comprising one or more lens 161, 162 to adjust divergence of the beam to a nominal focal length f₀ corresponding to a reference position 110 on the first surface 101 of the web 100, a galvanometer scanner 50 comprising a power supply and at least one moveable mirror 51, 52 for directing the beam transversely across a first surface 101 of the web adjacent to the beam source, and a focal adjuster 140 in the form of a flat field scanning lens 142, commonly referred to as an f-Theta lens, for focusing the beam as it is deflected by the scanner 50 transversely across the web surface from the reference position to an adjusted focal length f₁. Additional mirrors 70 may be provided to redirect the beam to suit spatial limitations in which the system may be positioned.

The flat field scanning lens 142 focal adjuster allows a beam to remain focused on a plane (the plane of the adjacent surface 101 in this case) as a scanner sweeps the beam from one edge to an opposite edge. The flat field scanning lens 142 is a passive component which, compared to the deformable mirror used in the heretofore described first embodiment, should improve reliability and durability of the laser beam delivery system 10. An additional advantage of the f-Theta lens is that the collimation system 160 is simplified as the flat field scanning lens performs as part of the beam adjustment optics thus reducing the number of discrete lens necessary in the system compared to the system using a deformable mirror.

In the exemplar second embodiment, the collimation system 160 includes a Thorlabs model LC1120-B first lens 161 having a focal length of -100 mm and a Thorlabs model LA1908-B second lens 162 having a focal length of +500 mm. The beam existing the collimation system is directed through the exemplar galvanometric scanner 50, model hurrySCAN®20 manufactured by SCANLAB. The scan-deflected beam is directed to the flat field scanning f-Theta lens 142, a Sill Optics Model S4LFT0910/328, which adjusts the final convergence of the beam and alters the focal length of the beam depending on the degree of beam deflection from the nominal position 110 (focal length f₀) toward the edges of the web 110a, 110b (adjusted focal length f₁).

The laser beam delivery system 10 further includes an optical sensor 80 having a sensing element 82 positioned to view a viewing surface of the web and detect the portion of the laser beam passing through the web. This portion of the laser beam is indicative that the laser has cut the web. The viewing surface may be the first surface 101 (observing the laser impingement on the surface), the second surface of the web 102 opposite of the adjacent first surface 101 (directly viewing the laser penetrating the web), or a viewing substrate 130 positioned adjacent to the second surface 102 of the web (indirectly viewing the portion of the laser beam passing through the web as it is reflected on the substrate). The laser may emit a beam having a wavelength that falls in the visible or invisible spectrum. Visible spectrum light may be viewed directly by the sensing element 82, with a brightness threshold established as the beam passes through the web material. Invisible spectrum lasers may be detected by the sensing element 82 by placing the viewing substrate 130 adjacent to the second surface 102. As the laser beam penetrates the web material, it interacts with the viewing substrate 130 causing an optical signal. The optical signal is visible to the sensing element 82 and therefore may be used to record the position and brightness of the signal. The optical sensor 80 sensing element 82 is configured to sense the beam position and beam intensity which is indicative of degree and configuration of perforation in the web caused by the beam. The sensor 80 then generates signals indicative of the degree and configuration of perforation and communicates these feedback signals to the controller 30. The controller 30 compares the feedback signals to target values selectively input by the user and generates output signals to manage operation of the laser to implement a desired laser perforation of the web. The optical sensor 80 is sensing the effectiveness of the laser in performing the perforation, that is the energy absorbed by the web material. Adjustments to the laser 20 are thus intended to alter the energy absorbed and may be accomplished by altering the laser pulse rate, the laser pulse energy, or a combination thereof.

The optical sensor 80 allows the laser beam delivery system 10 to be optimized based on the web material and/or type of processing required. The optical sensor 80 can detect the perforation pattern and spacing interval and provide feedback to the controller 30 which is compared to the input perforation parameters and allow for real-time adjustment of process parameters such as web speed, sweep rate, angle of the beam sweep ⊖, or mark and jump state control so that the desired perforation configuration is optimally applied to the web. Laser power may be controlled by varying beam output intensity, pulsing the beam, or by changing the pump current. Rather than a continuous energy level in the beam, the beam may be rapidly cycled between on and off states (modulated) to further control the energy input into the web material. Precision management of the energy input enable cutting on heat-sensitive materials, such as polypropylene, to be effected without burning or discoloring the material. Beam intensity (energy), pulse frequency, and pulse duration may be varied, alone or in combination, to achieve the ideal cutting performance. Additionally, the scanner-controlled speed of the beam sweep movement across the web may also be adjusted and influences the energy input into the material within the limitations necessitated by the web speed through the machine. All of these variables may be managed by the controller 30 using real-time performance feedback from the optical sensor 80.

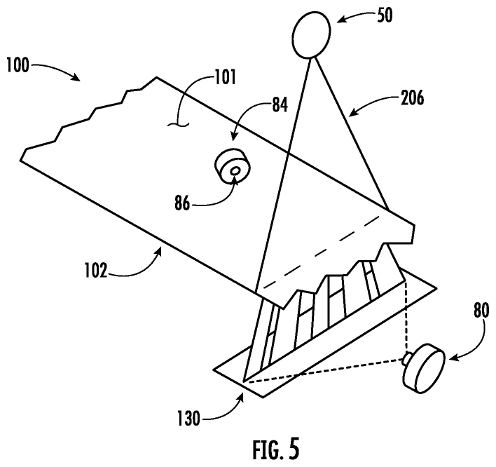

FIG. 5 illustrates one embodiment of the optical sensor 80 in which a viewing substrate 130 is positioned adjacent to the second surface 102 of the material web 100. As the laser beam penetrates the web material, it interacts with the viewing substrate 130 causing an optical signal to be formed even through the beam wavelength of the laser may not be in the visible portion of the light spectrum. The optical signal formed on the viewing substrate creates a pattern that is visible to and detected by the sensing element 82. A second optical sensor 84 may be positioned to view the adjacent surface 101 and detect discoloration of the web material that may occur with excessive laser power. The second optical sensor 84 having a sensing element 86 is also operably connected with the controller 30. The control algorithm may be configured to receive inputs from the first and second sensors 80, 84 and to manage the power output of the laser based on a combination of both feedback inputs.

The optical sensor 80 is configured to sense the laser beam, whether viewed directly or indirectly, such as when the beam is reflected from the viewing substrate 130. In the exemplar system, optical sensor 80 is a conventional web camera, such as a Model C270 by Logitech, focused on the viewing substrate 130. As the laser perforates the web and impinges on the substrate, a visible optical signal forms and is detected by the sensor. The controller 30 receives a baseline image of the viewing substrate 130 from the optical sensor 80 prior to laser activation. The controller 30 then compares the signal from the optical sensor as the laser interacts with the viewing substrate and “subtracts” the baseline image to achieve a representation of the perforation pattern. This representation is then compared to a desired pattern stored in the controller. The controller may then adjust the laser 20, scanner 50, and/or the dynamic focal adjuster 40 to achieve the desired perforation pattern and perforation quality.

The exemplar second optical sensor 84 may also comprise a conventional web camera, such as a Model C270 by Logitech. The purpose of the second sensor 84 is to detect burning or charring of the web material. The preferred web materials are normally white in color. The controller 30 is configured to convert the image signal from the second optical sensor 84 from RGB format to gray-scale format for easier comparison. A burn threshold in terms of a gray-scale pixel count adjacent to the laser path. The controller 30 then compares the gray-scale signal to the threshold and adjusts laser power accordingly to minimize discoloration of the web substrate.

A deformable mirror may be incorporated in combination with the flat field scanning lens to enable the controller to adjust the nominal focal length of the beam in response to changing conditions on the machine. Changes in the optical path due to thermal growth of the machine or variations in web thickness could be detected by changes in perforation quality detected by the optical sensor and compensated by adjustment of the deformable mirror. Unlike the first embodiment in which the deformable mirror is used to adjust focal length with each beam sweep, this configuration would compensate for changing conditions from the initial machine calibration that occur over time.

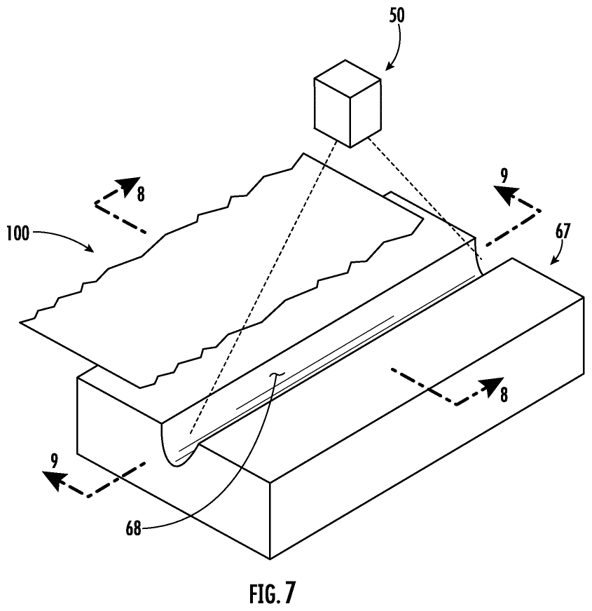

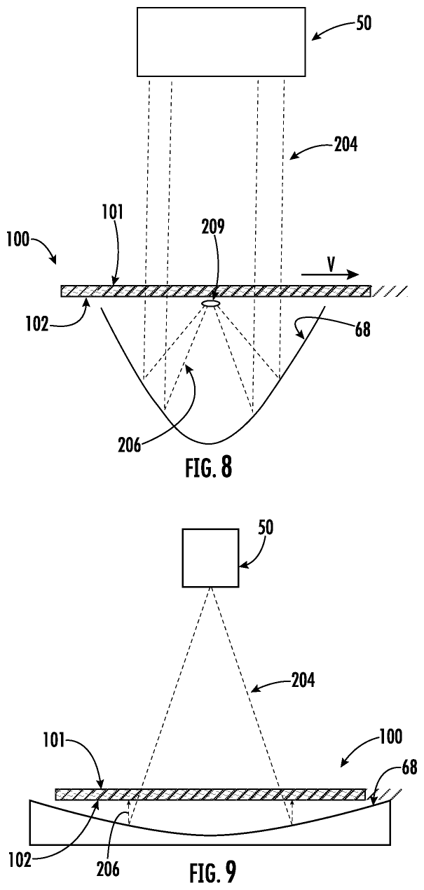

Referring to FIGS. 7 through 9, an alternative means of manipulating laser energy absorption and physically configuring the beam delivery system 10 in relation to the web 100. In this configuration the final stage of beam manipulation occurs adjacent to the second side 102 of the web, that is the side opposite of the laser source 20 and scanner 50. In this arrangement, the final collimating step, accomplished by collimating lens 63 or the flat field scanning lens 142 in the earlier described embodiments in now accomplished by a reflective member 67 positioned adjacent to the second surface 102 which reflects lower intensity laser beam 204 that passes through the web 100 to the second surface 102 to perforate the web from that side. The reflective member 67 comprises a reflective parabolic channel 68 positioned adjacent to the second surface 102, best illustrated in FIG. 8. The reflective parabolic channel 68 length is at least as much as the width of the web 100. The inward facing surface of the parabolic channel 68 is provided with a mirror-like finish. The parabolic channel 68 is configured with a focal length to reflect the transmitted lower intensity beam 204 and condensing the beam (focal length adjusted and shaped beam 206) to focused spot 209 on the second surface 102 of the web. The beam is swept laterally across the web as in other embodiments to implement the perforations on the web. An arc-like curvature in the transverse axis, illustrated in FIG. 9, compensates for the angled projection from the fixed-position scanner 50. The parabolic channel can be made of metals, ceramic materials or polymers, and a thin film coating of mirror-like finish applied.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiments of the invention; however, concepts, as based upon the description, may be employed in other embodiments without departing from the scope of the invention.

What is claimed is:

1. An apparatus for laser perforation of a moving web of material, the apparatus comprising:
a laser emitting a beam;
a controller for managing operation of the laser;
a scanner having a moveable mirror for directing the beam transversely across a first surface of the web, the web comprising a fabric material, movement of the moveable mirror managed by the controller;
a lens to adjust divergence of the beam to a nominal focal length f₀ corresponding to a reference position on the first surface of the web; and
a focusing element for focusing the beam as it is deflected by the scanner transversely across the first surface from the reference position to an adjusted focal length f₁ where f₁ is greater than f₀.

2. The apparatus of claim 1, further comprising a first optical sensor positioned to view a viewing surface, the optical sensor sensing the beam position and beam intensity on the viewing surface indicative of web perforation and communicating feedback signals indicative of beam position and intensity to the controller, the controller comparing the feedback signals to target values of beam position and intensity and managing operation of the laser to implement a desired laser perforation of the web.

3. The apparatus of claim 2, wherein the viewing surface is a viewing substrate positioned adjacent to a second surface of the web opposite of the first surface such that the beam passing through the perforations formed in the web impinges on the viewing substrate and is sensed by the first optical sensor.

4. The apparatus of claim 3, further comprising a second optical sensor positioned to view the first surface of the web

5. The apparatus of claim 2, wherein the viewing surface is the web of material.

6. The apparatus of claim 1, wherein the focusing element comprises a flat field scanning lens.

7. The apparatus of claim 1, wherein the focusing element comprises a dynamically deformable mirror operably connected to the controller.

8. The apparatus of claim 2, wherein the controller manages laser power by varying beam output intensity, pulsing the beam, changing the pump current, modulating beam pulse frequency, modulating laser pulse shape or a combination thereof.

9. The apparatus of claim 8, wherein intensity of the beam at the reference position on the first surface of the web is adjustable by the operation of the lens and the focusing element.

10. The apparatus of claim 9, wherein laser power may be adjusted to deliver laser beam intensity to the web in a linear absorption region of a web material or a non-linear absorption region of the material.

11. The apparatus of claim 8, wherein the controller modulates laser pulse shape to increase the derivative of the laser intensity with respect to time to cause self-phase modulation to occur in the web.

12. The apparatus of claim 1, wherein the fabric material is a non-woven.

13. An apparatus for laser perforation of a web of fabric material as it is moved along a feed conveyor in a web processing machine, the apparatus comprising;
a controller for managing operation of the laser perforation apparatus;
a laser emitting a beam, the laser operably connected to the controller;
a scanner for directing the beam transversely across a first surface of the web, the scanner operably connected to the controller;
a lens to adjust divergence of the beam to a nominal focal length f₀ corresponding to a reference position on the first surface of the web; and
a focusing element for focusing the beam as it is deflected by the scanner transversely across the first surface from the reference position to an adjusted focal length f₁ where f₁ is greater than f₀;
the controller further managing velocity of web movement along the feed conveyor, managing the scanner to direct the beam transversely across the moving web, and managing the laser to perforate the web to effect a desired perforation configuration on the web as the web is moved along the feed conveyor.

14. The apparatus of claim 13, further comprising an optical sensor positioned to observe the portion of the beam passing through the web, sense beam position and beam intensity indicative of perforation of the web, and communicate feedback signals indicative of beam position and intensity to the controller, the controller comparing the feedback signals to target values of beam position and intensity representative of the desired perforation configuration, and, in response, managing operation of the laser to vary laser power needed to implement the desired perforation configuration of the web.

15. The apparatus of claim 14, wherein the controller manages laser power by varying beam output intensity, pulsing the beam, changing the pump current, modulating beam pulse frequency, modulating laser pulse shape or a combination thereof.

16. The apparatus of claim 15, wherein laser power may be adjusted to deliver laser beam intensity to the reference position on the first surface of the web in a linear absorption region of a web material or a non-linear absorption region of the material.

17. The apparatus of claim 16, wherein laser power is delivered to the web, the laser having a wavelength within a linear absorption region of the web material.

18. The apparatus of claim 16, wherein the controller modulates laser pulse shape to increase the derivative of the laser intensity with respect to time to cause self-phase modulation to occur in the web.

19. The apparatus of claim 13, wherein the fabric material is a non-woven.
